(19) United States
(12) Patent Application Publication
(10) Pub. No.: US 2023/0114465 A1
(43) Pub. Date: Apr. 13, 2023

(54) POLYMER MATRIX BASED SUPERABSORBENT MATERIAL

(71) Applicant: SABANCI UNIVERSITESI, Istanbul (TR)

(72) Inventors: Merve Senem SEVEN, Istanbul (TR); Yesim MENCELOGLU, Istanbul (TR); Ogeday RODOP, Istanbul (TR); Yusuf Ziya MENCELOGLU, Istanbul (TR)

(73) Assignee: SABANCI UNIVERSITESI, Istanbul (TR)

(21) Appl. No.: 17/801,281

(22) PCT Filed: Feb. 20, 2021
(86) PCT No.: PCT/TR2021/050162

§ 371 Date: Aug. 22, 2022

(30) Foreign Application Priority Data
Feb. 20, 2020 (TR) 2020/02652

(51) Int. Cl. C08F 220/56; C08K 9/04; C08K 3/34; C08K 3/04

(52) U.S. Cl. CPC C08F 220/56; C08K 9/04; C08K 3/346; C08K 3/041; C08K 3/042

(57) ABSTRACT

A polymer matrix based superabsorbent material is provided, which is made of a polymer including nanoparticles with a particle size in the range of 0.1-500 nanometers, one or more water-soluble monomers suitable for radical polymerization, and at least one vinyl alkoxysilane derivative agent as a crosslinker. A method of producing the polymer matrix based superabsorbent material is also provided, which includes steps of: obtaining a solution by adding a solvent to the one or more water-soluble monomers suitable for the radical polymerization, obtaining a reaction mixture by adding the at least one vinyl alkoxysilane derivative agent as the crosslinker to the solution, adding the nanoparticles with the particle size in the range of 0.1-500 nanometers to the reaction mixture, and obtaining the polymer by a polymerization process.

### CROSS REFERENCE TO THE RELATED APPLICATIONS

This application is the national phase entry of International Application No. PCT/TR2021/050162, filed on Feb. 20, 2021, which is based upon and claims priority to Turkish Patent Application No. 2020/02652, filed on Feb. 20, 2020, the entire contents of which are incorporated herein by reference.

### TECHNICAL FIELD

The present invention relates to polymeric superabsorbent materials and production methods thereof. More particularly, the present invention relates to polymer matrix based superabsorbent materials with high swelling capacity and mechanical strength, and methods for the preparation thereof.

### BACKGROUND

In agriculture, horticulture and cultivation applications; biomedical applications such as controlled drug release, and wound bandages; various industrial applications such as waterproofing cable, ice pack, inflatable anti-flood sandbag, and moisture absorber; hygiene related applications such as diapers; construction applications; and refining applications such as nanofiltration where the fluid in the environment is absorbed and kept in the material for a certain period of time without being released to the environment.

At this point, superabsorbent polymers are preferred due to their water retention properties. Superabsorbent polymers (SAP) are cross-linked, water-insoluble, hydrophilic synthetic materials that can absorb fluids hundreds of times their own weight.

Said superabsorbent polymers are expected to have high swelling capacities in order to absorb the fluid in the environment. However, high swelling capacity may not always be sufficient. Superabsorbent polymers with high swelling capacities may have a loose structure when the swelling is completed. In such a case, even if low pressure is applied, the polymeric structure may easily break down.

In addition to good mechanical properties such as strength, flexibility, elasticity, resilience and rigidity, the superabsorbent polymers are intended to absorb a high amount of fluid and retain it for the desired period of time. In other words, superabsorbent polymers are expected to have both high fluid absorption capacity and adequate resistance to external effects.

The crosslinking density of the polymeric structure with super absorbent characteristics directly affects the fluid absorption capacity and gel strength of said polymeric structure. Fluid absorption capacity is a measure of the amount of fluid that is absorbed in a certain time by a certain amount of superabsorbent polymer. Polymers with low absorption capacities cannot sufficiently absorb the fluid in their environment. Gel strength indicates the resistance of the superabsorbent polymer in gel form to deform under pressure. Polymeric structures having inadequate gel strength are easily deformed, which negatively affects both the fluid absorption capacity and the homogeneous distribution of the fluid in the polymeric structure.

The proposed alternatives for increasing the fluid absorption capacity of the superabsorbent polymers fail to provide solutions for desired gel strength and release rate of the fluid retained in the structure of the polymeric material. In this regard, such ideal polymeric material is expected to absorb the fluid in the environment quickly and retain the fluid stored inside its structure without being released upon pressure. The polymeric structure of most superabsorbent polymers with high swelling capacities, which absorbs the fluid and swells, is often fragile and has a very low mechanical resistance. In cases where the cross-linking density is increased to improve the mechanical properties, it has been observed that the polymeric material swells less. Polymeric materials with both sufficient swelling capacity and improved mechanical properties are not yet available in the art.

U.S. Pat. No. 3,935,099 describes a starch-based copolymer which can absorb water. PCT patent application numbered WO 2005/059023 discloses a method for obtaining a starch-graft copolymer by graft polymerization of a graft agent on starch, for use in agricultural applications. Although the polymeric structures obtained by the graft polymerization method using biopolymers such as starch, cellulose, and chitosan, absorb the fluid in the environment; biopolymer-containing structures are not preferred due to the use of natural resources and the limited availability of said resources.

Therefore, in order not to consume the natural resources, it is preferred to use synthetic components in the production of superabsorbent polymers. A polymeric material that confers the desired results in terms of both swelling and release properties and mechanical properties has not yet been provided. Since some of the polymers known in the art cannot absorb fluid sufficiently. they do not swell to the desired extent and/or they release the absorbed fluid quicker than required or at an earlier time. Such situations pose a problem during the application. Furthermore, apart from the properties of swelling and release of the absorbed fluid of the polymer, the mechanical properties of said polymer are quite important. For example, the polymer structure may disintegrate under pressure.

In brief, superabsorbent polymers that cannot absorb sufficient amount of fluid and do not satisfy the desired mechanical properties are not preferred because they do not provide the desired results in practice. Accordingly, there is a need for polymer systems with high swelling capacity and improved mechanical properties.

### SUMMARY

The main object of the present invention is to overcome the technical problems encountered in the prior art.

Another object of the present invention is to increase the swelling capacity and swelling rate of a polymeric material so that said material can absorb more water.

Another object of the present invention is to obtain a polymeric material that releases the absorbed fluid slowly to its environment.

Another object of the present invention is to obtain a superabsorbent material that can maintain its structure for a longer period of time when under pressure.

The present invention discloses a polymer matrix based superabsorbent material made of a polymer comprising nanoparticles with a particle size in the range of 0.1-500 nanometers, one or more water-soluble monomers suitable for radical polymerization, and at least one vinyl alkoxysilane derivative agent as a crosslinker.

### DETAILED DESCRIPTION OF THE EMBODIMENTS

The present invention provides a superabsorbent material having a polymeric structure. The polymeric material of the invention is made of a polymer comprising nanoparticles with a particle size in the range of 0.1-500 nanometers, one or more water-soluble monomers suitable for radical polymerization, and at least one vinyl alkoxysilane derivative agent as a crosslinker. As used herein, the monomer is a water-soluble monomer that is suitable for radical polymerization. Monomers suitable for radical polymerization are monomers that can converted into free radicals by physical or chemical factors. A polymer chain grows by the addition of monomer units, one by one, to the active cores, i.e., to the growing chain, and once proliferation in the polymer chain ceases, polymerization is completed.

Said polymer matrix based superabsorbent material comprises one or more of ionizable; anionic; cationic; zwitterionic; or vinylic, acrylic and allylic monomers that contain multiple functional groups.

In another embodiment of the present invention, said monomers comprise one or more of vinylic, acrylic and allylic monomers containing ionizable, anionic, cationic or zwitterionic functional groups.

In another embodiment of the invention, the polymer matrix based superabsorbent material may contain three different monomers.

The choice of monomers directly affects the swelling capacity of the superabsorbent polymer material. The swelling capacity is one of the most important parameters in determining the characteristics of the superabsorbent polymer. The superabsorbent polymer is expected to absorb fluid at the maximum level, regardless of its application area. The more the polymeric structure swells, the more fluid it can hold. The superabsorbent polymer, which acts as a water reservoir in applications such as agriculture and horticulture, first absorbs the water in the environment and then releases the water contained in its own structure. The superabsorbent polymers used in hygiene group products and construction applications are expected to only absorb the fluid in the environment.

According to the invention, ionizable; anionic; cationic; zwitterionic; or vinylic monomers that contain multiple functional groups may be acrylic acid, methacrylic acid and its esters, and acrylamide and its derivatives. Ionizable monomers may be sulfone, and those containing carboxylate groups; anionic monomers may be acrylic acid, methacrylic acid; cationic monomers may be those containing quaternary ammonium group and primary, secondary, tertiary amino group as side chain; zwitterionic monomers may be acrylic, vinylic, allylic monomers containing side groups; and those containing multiple functional groups may be acrylic monomers, preferably AMPS.

In another embodiment of the invention, said monomer comprises acrylic acid, acrylamide, AMPS (2-acrylamido-2-methylpropane sulfonic acid) or a combination thereof.

In another embodiment of the invention, acrylic acid, acrylamide and AMPS are used.

In another embodiment of the invention, the molar ratios of acrylic acid:acrylamide:AMPS monomers to each other may be in the range of 1:4:1 to 1:0.5:1, preferably 1:2:1.

Crosslinkers are sometimes incorporated into the polymer chain after polymerization is completed. In this case, they are connected via the functional group without being involved in polymer formation.

In the present invention, said vinyl alkoxysilane derivative is both responsible for the crosslinking in the polymer and included in the polymer as a monomer. In other words, when the vinyl alkoxysilane derivative is used, monomers are cross-linked during the polymerization reaction and form the polymer chain. It has been observed that vinyl alkoxysilane derivatives enhance the crosslinking activity of the resulting polymer chain and thus the polymerization reaction proceeds faster. Another benefit of using a vinyl alkoxysilane derivative agent in the superabsorbent polymeric material is that it allows the resulting polymeric material to adhere to different types of surfaces. Thus, said superabsorbent polymeric materials can easily adhere to surfaces such as soil, glass, concrete or textiles, regardless of the form of their surface.

For example, in agricultural applications, polymeric materials embedded in the soil without requiring any surface, may sometimes be embedded in the soil after having been fixed to a surface of a biological material such as cellulose. In case the vinyl alkoxysilane derivative is not included in the polymerization reaction, the polymeric material, which is the final product, could not be fixed to the surface of another material by adhering.

It has been observed that the polymeric structure has a more flexible structure owed to the vinyl alkoxysilane derivative agent that is included in the polymer system as a monomer. It is observed that the swelling capacity of said material is improved due to the flexible structure of the polymer matrix based superabsorbent material.

At least one vinyl alkoxysilane derivative component is added as a crosslinker to the polymerization reaction initiated with the monomers according to the invention. The vinyl alkoxysilane derivatives according to the invention may be vinyltrimethoxysilane (VTMS), triethoxyvinylsilane (TEVS) and tri(2-methoxyethoxy)vinylsilane (TMEVS). Said vinyl alkoxysilane derivative crosslinker allows the formation of a self-crosslinkable polymer chain. The need for an extra acid or base catalyst enabling crosslinking is eliminated in a self-crosslinking polymer.

The vinyl alkoxysilane derivative used in the polymerization reaction affects both the swelling characteristics and the mechanical properties of the polymeric material to be obtained. In cases where the polymeric structure does not have enough crosslinkers, even if the polymerization reaction takes place, dissolution occurs in the polymeric structure instead of swelling. On the contrary, if the crosslinker is more than necessary, a very rigid polymeric material is obtained, which prevents the swelling of the material. In another embodiment of the invention, in terms of molar ratio, the ratio of vinyl alkoxysilane derivative to all monomers used may be in the range of 0.01-1, preferably 0.1-0.5, more preferably 0.15-3.

In another embodiment of the invention; the crosslinker further comprises PEG polymer chains, including but not limited to PEG 400, PEG 1000, PEG 2000, and PEG 4000.

According to another embodiment of the invention, the crosslinker is PEG alone.

According to the invention, the polymer matrix based superabsorbent material further contains nanoparticles with a particle size in the range of 0.1-500 nanometers.

Apart from the swelling capacity of the superabsorbent polymeric material, the speed and duration of the release of the fluid contained therein is also of great importance. Materials of this structure release the fluid contained therein within an average of 24 hours. However, in some applications such as in agriculture and horticulture, it is aimed that said fluid releases more slowly and the fluid release continues for a longer period of time.

The fluid release in the polymer matrix based superabsorbent material containing the nanoparticles with said particle size is slowed down, thus the duration of the release is prolonged. Due to this effect, in activities such as agriculture and horticulture where irrigation is needed, the release of water in a controlled manner for a longer period of time has provided great convenience in practice.

On the other hand, another problem with the superabsorbent polymeric materials is the rapid release of the fluid in the polymeric material which causes a burst effect. In particular, polymeric materials that are exposed to high pressure can release the fluid contained therein very quickly. It is observed that, even under high pressure, the superabsorbent material containing nanoparticles with a particle size in the range of 0.1-500 nanometers has a high capacity to absorb and retain the fluid.

The particle size of nanoparticles can be measured by one of the methods known in the art, such as Scanning Electron Microscope (SEM), Dynamic Light Scattering (DLS) or Atomic Fluorescence Spectrometer (AFS).

The addition of nanoparticles mentioned herein has significantly improved the mechanical strength of the polymer matrix-based material obtained according to the invention. The elastic modulus is evaluated for the mechanical strength of the materials in gel form. It is observed that the elastic modulus, which is the measure of the elastic deformation of the material under force, increases by the addition of nanoparticles, with a particle size in the range of 0.1-500 nanometers, to the polymer matrix based superabsorbent material. The increase in the elastic modulus of the superabsorbent material is an evidence of its increased mechanical strength. In other words, it can be said that the superabsorbent material can remain under pressure for a longer time.

In addition, it has been observed that the use of nanoparticles with a particle size in the range of 0.1-500 nanometers contributes to a prolonged release of the fluid in the superabsorbent material. In another embodiment of the invention, the particle size of the nanoparticles in the polymer matrix based superabsorbent material can be in the range of 1-100 nanometers.

According to the invention, the nanoparticles used in said superabsorbent material consist of organic and/or inorganic components. Nanoparticles can have spherical, quantum dot, nano-dot, nano-rod or tubular form.

In another embodiment of the invention, nanoparticles in tubular form can be used. Thus, a superabsorbent material with better mechanical properties is obtained.

In another embodiment of the invention, the nanoparticle in the polymer matrix based superabsorbent material may be halloysite, carbon nanotube, graphene or a combination thereof. The carbon nanotube used herein can be in a tubular or plate form.

The amount of nanoparticles in the polymer matrix based superabsorbent material may be in the range of 0.01-50%, preferably 0.1-30%, more preferably 1-5% by weight of the total weight of said polymer.

In another embodiment of the invention, the amount of nanoparticles in the polymer matrix based superabsorbent material is preferably in the range of 0.01-10%, more preferably 0.1-5% by weight of the total weight of said polymer.

In another embodiment of the invention, the nanoparticles in the polymer matrix based superabsorbent material may comprise at least one active substance. Said active substance is loaded on the surface of the nanoparticles. While the superabsorbent material of the present invention releases the fluid therein, active substances loaded on the surface of the nanoparticles are also released. The release of the active substance may be desired to occur slower or faster based on the case. It has been found that the release rate of the active substance can be adjusted as desired, according to the region where the active substance is loaded on the surface of the nanoparticle. It has been determined that the loading of the active substances in the inner lumen of the nanoparticles provides a controlled release of active substance for a longer period of time, and loading of the active substance on the outer surface or interface of the nanoparticles provides a faster release of active substance. Accordingly, active substances in the polymer matrix based superabsorbent material may be loaded in the inner lumen, outer surface and/or interface of the nanoparticles.

The active substances according to the invention may be bioactive agents, plant growth hormone, soil-based nutrient, pesticide, acaricide, insecticide, nematicide, rodenticide, fungicide, herbicide, molluscicide, bactericide, anti-fungal agents, insect repellent and virucide.

Many of the applications where superabsorbent materials are used, especially agricultural and water treatment applications, includes various microorganisms. For instance, nitrifying bacteria accelerates the cycles of nitrification and denitrification. Said bacteria is responsible for the conversion of ammonium to the nitrate ions by the air in the environment. Once ammonium is transformed into nitrate ions, these nitrate ions are converted into nitrous oxide (NO₂) and nitrogen gas (N₂) through denitrification process. At the end of the reaction, nitrous oxide and nitrogen gas are emitted to the air; thereby resulting in nitrogen loss and greenhouse gas emissions, which are detrimental to nitrogen use efficiency, crop yield, and environmental health.

Nitrogen loss is one of the challenges in agricultural applications, water treatment applications and the applications where nitrate and ammonium ions are present. Nitrogen loss results in the reduction of nitrogen use efficiency. This represents a major economic loss, crop yield loss and a significant threat to groundwater quality.

Final products of the nitrogen cycle (nitrification and denitrification processes) are in gaseous form and release to the air easily. Of these products, nitrous oxide is a highly toxic, greenhouse gas that causes a significant increase in the global greenhouse gas emissions. Nitrous oxide is known as a potent greenhouse gas which has a global warming potential 265 times that of CO₂. Besides the ammonium and nitrate ions which are present in the environment; various additives may be used in these applications such as fertilizers. Fertilizers generally contain a high amount of nitrogen in nitrate form. However, nitrate ions leach to their environment, such as the soil. Another mechanism that causes nitrogen loss is the volatilization of ammonium. Ammonium may either be volatilized or converted into nitrate ions by nitrifying bacteria, both of which causes nitrogen loss. The volatilization of ammonium also needs to be minimized to reduce nitrogen loss.

Various active agents are used in the art for hindering the conversion of ammonium to nitrate and the volatilization of ammonium. Such an attempt minimizes nitrogen loss, nitrate leaching and decreases the nitrogen gas and nitrous oxide gas emissions to the air. Nitrification inhibitors and, urease inhibitors are the Most preferred agents for overcoming the drawback mentioned herein. Nitrification inhibitors are responsible for preventing the conversion of ammonium to nitrate; thereby also indirectly impeding the conversion of nitrate ions to gases of nitrous oxide and nitrogen due to the minimized concentration of nitrate ions present in the environment. Urease inhibitors are used for reducing the volatilization of ammonium. However, the application of nitrification inhibitors and urease inhibitors is sometimes challenging. The incorporation of said inhibitors does not always give the same results in different field trials due to various environmental factors. For example, nitrification and/or urease inhibitors embedded under the soil may leach quickly in wetter soils; thereby losing the inhibition effect quickly.

As the main object of the present invention is to provide a polymer matrix based super-absorbent polymer that has a high swelling capacity and a prolonged fluid release rate; active agents such as nitrification inhibitors and/or urease inhibitors are also incorporated into the polymer matrix based superabsorbent material of the invention. This practical system provides a significant contribution to increased agricultural product yield, reduction in nitrogen loss and alleviation of greenhouse gas emissions. On the other hand, inhibitors to be used according to the invention may have different half-lives depending on the temperature and other environmental conditions. For example, higher temperature causes a quicker degradation of the inhibitors. Another advantage of incorporating said inhibitors into the polymer-matrix based superabsorbent material of the invention is to impede the degradation of the inhibitor and prolong the duration of the release of the inhibitor due to the release mechanism of the superabsorbent material based on the absorbed fluid.

The underlying mechanism of this effect is related to the nanoparticles used in the superabsorbent material. Super-absorbent material of the present invention comprises nanoparticles which enhance mechanical properties and greatly prolongs (more than 10 times) its water retention capacity compared to most other superabsorbent materials. Since the polymer-matrix based superabsorbent material retains the fluid for a longer period of time, it will also retain the incorporated inhibitors for a longer period of time before they diffuse out to soil; hence providing an even better shielding effect compared to standard applications.

In another embodiment of the present invention, the active agent comprises nitrification inhibitor, urease inhibitor or a combination thereof. Alternatives for nitrification inhibitors are dicyandiamide (DCD), 3,4-dimethylepyrazole (DMPP), nitrapyrin and combinations thereof. Alternatives for urease inhibitors are N-(n-butyl) thiophosphoric triamide (NBPT), phenyl phosphorodiamidate (IPDA), hydroquinone and combinations thereof. Accordingly, nitrification inhibitors and urease inhibitors minimize the transformation of either ammonium or nitrate to nitrous oxide and nitrogen gases.

In another embodiment of the present invention; nitrification inhibitor and urease inhibitor are also added to the polymer chain as a monomer in addition to the above-mentioned monomers according to the invention.

Thus, the polymer-matrix based superabsorbent material according to the invention that also comprises a nitrification inhibitor, a urease inhibitor or a combination thereof minimizes the risk of nitrogen loss, nitrogen and nitrous oxide gas emissions, increases the agricultural product yield by minimizing the loss of the necessary minerals to the environment. The nitrification inhibitor, the urease inhibitor or a combination thereof is incorporated in the superabsorbent material.

The integration of said inhibitors to the polymer-matrix based superabsorbent material may be achieved through direct encapsulation of inhibitor with superabsorbent material, loading of nano-particles with said inhibitor prior to polymerization, incorporation of inhibitors to the polymerization reaction, adding inhibitor-loaded nano-particles to polymerization media prior to polymerization, physical mixing of inhibitor-loaded nano-particles and superabsorbent polymer material, or any combination of the above-mentioned techniques. The preferred methods are direct encapsulation of the inhibitor with the superabsorbent material and physical mixing of inhibitor-loaded nano-particles and superabsorbent polymer material.

According to another embodiment of the present invention, the polymer-matrix based superabsorbent material further comprises any kind of fertilizer. The fertilizer may be loaded on the surface of nanoparticles.

In another embodiment, said fertilizer may be incorporated into the superabsorbent material through direct encapsulation of fertilizer with superabsorbent polymer, loading of nano-particles with fertilizer prior to polymerization, incorporation of fertilizers to the polymerization reaction, adding fertilizer-loaded nano-particles to polymerization media prior to polymerization, physical mixing of fertilizer-loaded nano-particles and superabsorbent polymer material, or any combination of the above-mentioned techniques. The preferred method is direct encapsulation of the fertilizer with the superabsorbent polymer material.

In another embodiment of the present invention, the polymer-matrix based superabsorbent polymer may comprise both an active substance according to the invention and a fertilizer.

In another embodiment of the present invention, the nanoparticles in the polymer matrix based superabsorbent material may comprise at least one active substance in an amount of 0.01-50%, preferably 0.1-30%, more preferably 1-5% by weight.

According to the invention, the polymer matrix superabsorbent material obtained from the polymerization reaction may be subjected to post-processing for forming the material. In accordance with the invention, alternative post-processing methods may be drying by precipitation, electrospinning, electrospraying and film forming. The preferred polymer processing method in the present invention is electrospinning or electrospraying. As a result of forming said polymeric material by electrospinning or electrospraying methods, it is determined that the swelling rate of the polymer matrix based superabsorbent material is increased. In the electrospinning process, polymer fibers are formed in nano- or micro-sizes by directing the polymer to a specific target under high voltage. In this case, the resulting material has the form of electrospinned fibers. When the electrospraying method is used, said polymer is directed to a specific target under high voltage to form nano- or micro-sized polymer beads. The material thus obtained has the form of electrosprayed microbeads or nanobeads. Electrosprayed bead and electrospinned fiber forms are regular structures, and materials in these forms swell much faster when in contact with fluid. In another embodiment of the invention, a polymer matrix based superabsorbent material in the form of electrospinned fibers can be used.

The polymeric material described in the present invention is obtained by free radical polymerization based on the formation of the polymer chain by addition polymerization method. On the other hand, said polymeric material may be obtained by any of the methods of mass polymerization, solution polymerization, suspension polymerization, precipitate polymerization, gas phase polymerization, solid state polymerization or emulsion polymerization.

In the synthesis of the polymer described in the present invention, where it comprises one or more of ionizable; anionic; cationic; zwitterionic; or vinylic, acrylic and allylic monomers that contain multiple functional groups, an initiator agent can be used to initiate polymerization. The polymerization process is enabled by the addition of at least one initiator to the reaction mixture comprising said monomers and the crosslinker.

Preferably, a water-soluble initiator is used. Initiators according to the invention may be ammonium persulfate; N,N,N′,N′-tetramethylethylenediamine (TEMED); inorganic peroxides such as terbutylhydroperoxide, terbutylperacetate, benzoyl peroxide; organic azo compounds such as azobisisobutyronitrile (AIBN), azobiscyanopentanoic acid, cyclohexane carbonitrile; preferably ammonium persulfate is used. The addition of an initiator is not a necessity for the polymerization reaction to take place; the polymerization reaction may start in the presence of some monomers without requiring a chemical substance due to the factors such as heat and light. According to the invention, a method of producing a polymer matrix based superabsorbent material comprises the steps of:
a. obtaining a solution by adding a solvent to one or more water-soluble monomers suitable for radical polymerization,
b. obtaining a reaction mixture by adding at least one vinyl alkoxysilane derivative agent as a crosslinker to said solution,
c. adding nanoparticles with a particle size in the range of 0.1-500 nanometers to the reaction mixture obtained in step (b),
d. obtaining a polymer by a polymerization process.

In the steps mentioned herein, the reaction temperature may be in the range of 50-85° C.

According to the invention, said polymer can be prepared according to free radical polymerization.

After the polymer is obtained, it can be subjected to post-processing for forming said polymer. Any of the methods of drying by precipitation, electrospinning, electrospraying, or film forming can be used as the post-processing method. According to the invention, electrospinning or electrospraying of said polymeric structure is preferred. It has been observed that the polymeric material formed by electrospinning or electrospraying methods exhibits faster swelling performance. The fiber and bead forms obtained from these methods are regular structures and materials in these forms swell much faster when in contact with fluid. Polymer fibers are obtained at the end of the electrospinning process, while polymer beads are obtained in the electrospraying process. In another embodiment of the invention, electrospinning is applied as post-processing to obtain the polymeric material in fiber form.

The monomers used to produce polymers may comprise one or more of ionizable; anionic; cationic; zwitterionic; or vinylic, acrylic or allylic monomers containing multiple functional groups.

In another embodiment of the present invention, said monomers may comprise one or more of vinylic, acrylic and allylic monomers that contain ionizable, anionic, cationic or zwitterionic functional groups.

There are preferably three different monomers according to the invention. Said monomers are acrylic acid, acrylamide and AMPS.

In another embodiment of the invention, at least one initiator may be added to the reaction mixture to which the nanoparticles are added.

According to the invention, the solvent that is mixed to form a solution with one or more water-soluble monomers suitable for radical polymerization may be water, dimethylacetamide, or dimethylformamide. Water is preferably used as solvent. When water is used as a solvent in the polymerization reaction, a more economical, more environmentally friendly and more practical production method is implemented.

The nanoparticles in the polymer matrix based superabsorbent material may comprise at least one active substance on their surface. The method performed to obtain nanoparticles that are loaded with active substances comprises the steps of:
subjecting the suspension containing nanoparticles with at least one active substance to vacuuming,
separating said nanoparticles loaded with active substances from the suspension and drying the same.

Following these method steps, the nanoparticles loaded with the active substance, which are separated from the suspension and dried, are combined with the polymer obtained according to the production method of the invention.

According to another embodiment of the present invention, nanoparticles are physically mixed and compounded with the synthesized polymer. Hence, nanocomposites superabsorbent material is obtained. Said nanoparticles can either be loaded with the active substance or not loaded with any active substance.

Described below is an exemplary embodiment of the polymer matrix based superabsorbent material according to the present invention. The intended scope of the present invention is defined by the claims and is not limited to the content of the example.

### EXAMPLE 1:

According to an embodiment of the invention, the quantities of components used in polymer synthesis as well as the reaction temperature and time are mentioned below.

Acrylic acid: 3.15 g

Acrylamide: 8.02 g

AMPS: 1 g

VTMS: 0.19 g

Ammonium persulfate: 0.06 g

Water: 100 mL

Reaction temperature: 50-85° C.

Reaction time: 1-3 hours

Accordingly, acrylamide and AMPS are dissolved in 15 mL of water, acrylic acid is added to this solution. For neutralization, sodium hydroxide is added to the solution, which becomes clear upon the mixing step. The solution is completed to 100 mL by the addition of water. Then, the monomer solution is purged with nitrogen to remove the excess oxygen in the reaction medium. After the mixture is bubbled with nitrogen gas for 15 minutes, VTMS is added to the mixture under vigorous stirring. The mixture is subjected to stirring and bubbling for 15 minutes more to remove the excess oxygen and air from the reaction medium. In another vessel, ammonium persulfate is dissolved in 5 mL of water and then added to the reaction mixture. Polymerization is carried out in an oil bath at 78° C. for 2 hours. The viscous polymer solution obtained at the end of the reaction is cooled to room temperature. Finally, the resulting polymer is precipitated in the form of a white powder in ethanol or methanol, and it is dried at 70° C. for 2 days. In order to obtain nanoparticles loaded with active substance on their surface, the nanoparticles are mixed with the active substance and a suspension in water is prepared. Vacuum is applied while under constant mixing. During vacuuming, foaming is observed, and vacuum is applied until bubbling stops. At this point, the mixture is brought to atmospheric pressure for 2 to 3 minutes. This vacuum cycle is repeated twice more for optimum loading of the nanoparticles with the active substance. The solid content of the suspension is filtered by vacuum filtration or centrifugation. The resulting nanoparticles are washed with distilled water and dried in air. The inner lumen, interface or outer surface of the nanoparticles may be loaded with the active substance.

As a result, the nanoparticles loaded with the active substance, are combined with the synthesized polymer by various methods to obtain a nanocomposite material. Nanostructures in fiber or bead forms are provided by forming the polymer matrix based superabsorbent material with a post processing method such as electrospinning or electrospraying.

What is claimed is:

1-31. (canceled)

32. A polymer matrix based superabsorbent material, wherein the material is made of a polymer comprising nanoparticles with a particle size in a range of 0.1-500 nanometers, one or more water-soluble monomers suitable for a radical polymerization, and at least one vinyl alkoxysilane derivative agent as a crosslinker.

33. The polymer matrix based superabsorbent material according to claim 32, wherein the one or more water-soluble monomers comprise at least one of acrylic acid, acrylamide, and AMPS (2-acrylamide-2-methylpropane sulfonic acid).

34. The polymer matrix based superabsorbent material according to claim 32, wherein the crosslinker comprises at least one of vinyltrimethoxysilane (VTMS), triethoxyvinylsilane (TEVS), and tri(2-methoxyethoxy)vinylsilane (TMEVS).

35. The polymer matrix based superabsorbent material according to claim 34, wherein the crosslinker further comprises PEG polymer chains.

36. The polymer matrix based superabsorbent material according to claim 32, wherein the particle size of the nanoparticles is in the range of 1-100 nanometers.

37. The polymer matrix based superabsorbent material according to claim 32, wherein the nanoparticles comprise at least one of halloysite, carbon nanotube, and graphene.

38. The polymer matrix based superabsorbent material according to claim 32, wherein an amount of the nanoparticles is in a range of 0.01-10% by weight of a total weight of the polymer.

39. The polymer matrix based superabsorbent material according to claim 32, wherein the nanoparticles have at least one active substance on a surface of the nanoparticles; and the at least one active substance is a nitrification inhibitor, a urease inhibitor, or a combination of the nitrification inhibitor and the urease inhibitor.

40. The polymer matrix based superabsorbent material according to claim 39; wherein the nitrification inhibitor is at least one of Dicyandiamide (DCD), 3,4-dimethylepyrazole (DMPP), and nitrapyrin.

41. The polymer matrix based superabsorbent material according to claim 39; wherein the urease inhibitor is at least one of N-(n-butyl) thiophosphoric triamide (NBPT), phenyl phosphorodiamidate (PPDA), and hydroquinone.

42. The polymer matrix based superabsorbent material according to claim 39, wherein the nanoparticles comprise the at least one active substance in an amount of 0.01-50% by weight.

43. The polymer matrix based superabsorbent material according to claim 32, wherein the polymer matrix based superabsorbent material further comprises a fertilizer.

44. The polymer matrix based superabsorbent material according to claim 32, wherein the polymer further comprises an initiator.

45. The polymer matrix based superabsorbent material according to claim 44, wherein the initiator is ammonium persulfate.

46. The polymer matrix based superabsorbent material according to claim 32, wherein the polymer matrix based superabsorbent material is in a form of electrospinned fibers, electrosprayed nano-beads, or electrosprayed micro-beads.

47. A method of producing the polymer matrix based superabsorbent material according to claim 32, comprising steps of:
a obtaining a solution by adding a solvent to the one or more water-soluble monomers suitable for the radical polymerization,
b. obtaining a reaction mixture by adding the at least one vinyl alkoxysilane derivative agent as the crosslinker to the solution,
c. adding the nanoparticles with the particle size in the range of 0.1-500 nanometers to the reaction mixture obtained in step (b),
d. obtaining the polymer by a polymerization process.

48. The method according to claim 47, wherein the one or more water-soluble monomers are at least one of acrylic acid, acrylamide, and AMPS (2-acrylamido-2-methylpropane sulfonic acid).

49. The method according to claim 47, wherein the steps of the method are performed at a temperature in a range of 50-85° C.

50. The method according to claim 47, wherein the nanoparticles comprise at least one active substance loaded in an inner lumen, an outer surface and/or an interface of the nanoparticles.

51. The method according to claim 50, further comprising steps of:
subjecting a suspension containing the nanoparticles with the at least one active substance to vacuuming to load the nanoparticles with the at least one active substance,
separating the nanoparticles loaded with the at least one active substance from the suspension and drying separated nanoparticles.
